(19) United States
(12) Patent Application Publication
(10) Pub. No.: US 2010/0084148 A1
(43) Pub. Date: Apr. 8, 2010

(54) TANDEM DISK WITH FINISHING REEL

(75) Inventors: Michael G. Kovach, Morton, IL (US); Rickey L. Gerber, Roanoke, IL (US); Melvin L. Blunier, Congerville, IL (US); Mark P. Hoffman, Deer Creek, IL (US)

Correspondence Address: CNH America LLC;Intellectual Property Law Department, PO BOX 1895, M.S. 641, New Holland, PA, 17557, US

(73) Assignee: CNH America LLC, New Holland, PA (US)

(21) Appl. No.: 12/247,579

(22) Filed: Oct. 8, 2008

(51) Int. Cl. A01B 49/02

(52) U.S. Cl. 172/145

(57) ABSTRACT

Embodiments of the present invention provide a novel configuration for agricultural tandem disk systems that feature soil finishing systems. This configuration of the finishing system features finishing reels that provide a robust assembly that will require less frequent repair and maintenance. The finishing system also features support arms that allow the user to adjust the position of finishing reels and the downward force applied to the reels. In an exemplary embodiment, the soil finishing reels are located behind two rows of ground breaking disk blades. After the soil is opened by the disks, the finishing reel may be used to break up or split large soil clods created by the disks. The soil finishing system allows the user to have the soil in an optimized state for germination after one pass of the agricultural system, reducing the number of passes needed to prepare the field.

### BACKGROUND

The invention relates generally to agricultural implements, such as tandem disk systems, used in farming operations. More particularly, the invention relates to a tandem disk system featuring a soil finishing system.

A tandem disk system is used to break up the ground to prepare for seed deposition. A soil finishing system is used along the ground after the tandem disk system to create a desirable finish for farming. Current tandem disk soil finishing systems may contain spike or tine harrows to achieve a desired soil finish. The tines may bend or break after usage and wear. In the case of spike harrows, they may bunch, clog and plug with residue, thus will not break clods and smooth soil. Further, the tines may be composed of a metal that may bend or break as the harrows or tines are dragged across rocks and/or large clods of soil. Moreover, tines do not have sufficient down pressure to break larger soil clods and smooth the soil.

### BRIEF DESCRIPTION

Embodiments of the present invention provide a novel configuration for agricultural tandem disk systems that feature soil finishing systems. This configuration of the finishing system features finishing reels that provide a robust assembly, resulting in reduced repair and maintenance costs. The finishing system also features support arms that allow the user to adjust the position of finishing reels and the downward force applied to the reels. In an exemplary embodiment, the soil finishing reels are located behind two rows of ground breaking disk blades. After the soil is opened by the disks, the finishing reel may be used to break up or split large soil clods formed by the disks. The soil finishing system allows the user to have the soil in an optimized state for germination after one pass of the agricultural system, thereby reducing the number of passes needed to prepare the field.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of a tandem disk system having a soil finishing system;

FIG. 2 is a top view of an embodiment of the system of FIG. 1;

FIG. 3 is a side view of an embodiment of the system of FIG. 1, illustrating a transport configuration having transport wheels extended and finishing reels and disks out of contact with the ground;

FIG. 4 is perspective view of an embodiment of the soil finishing system of FIG. 1, illustrating details of the finishing reel and support arms; and

FIGS. 5A and 5B are cross-sectional side views of an embodiment of the finishing reel of in FIG. 4.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

As discussed in detail below, various configurations of disk and soil finishing systems may be employed to produce an optimal soil finish, improve reliability, and reduce maintenance. For example, the embodiments discussed below may employ rows of disks, finishing reels extending from support arms that include biasing members, and soil contacting bars included in the finishing reels to split or break soil clods. Specifically, the finishing reels rotate about an axis as the disks and reels are towed across a terrain. The biasing members may urge the reels into the terrain and may enable a position adjustment of the finishing reels. The support arms may also include a position adjustment allowing a position adjustment of the finishing reels. For example, the finishing reels may be towed across a terrain behind two disk rows, thereby producing a terrain surface that is optimal for seeding or farming.

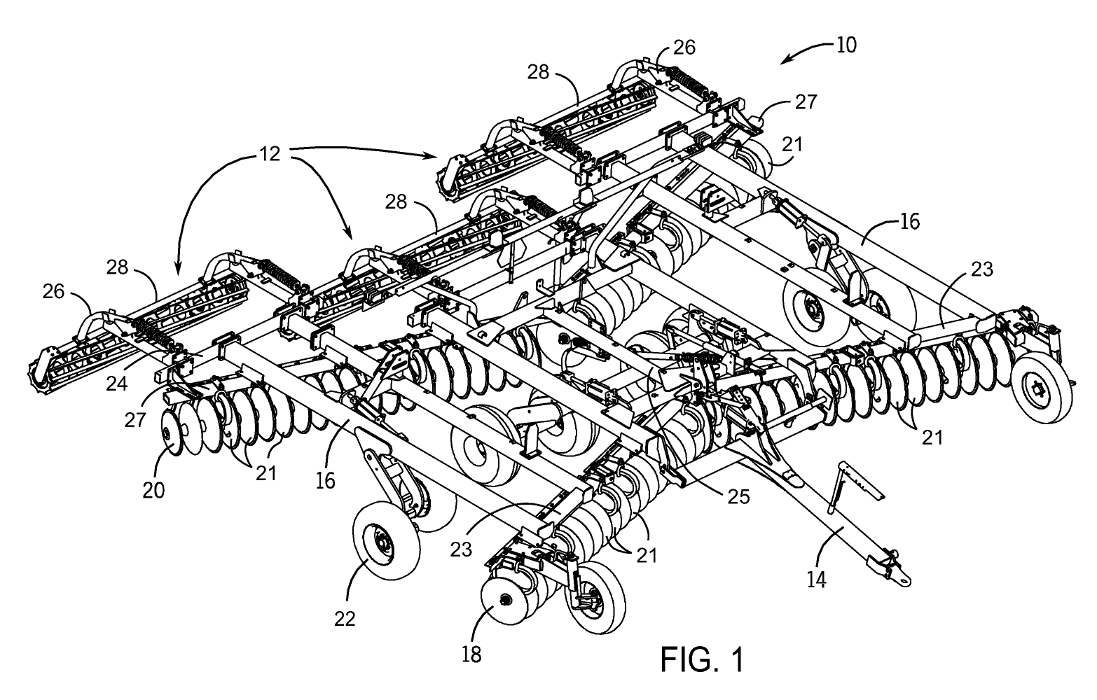

Turning now to the drawings and referring first to FIG. 1, an embodiment of a tandem disk system is illustrated and designated generally by reference numeral 10. In the present context, the tandem disk system 10 may also be referred to as a tandem disk assembly, a soil conditioning system, an opener system/assembly or a ground breaking system/assembly.

Tandem disk system 10 includes soil finishing systems 12. As discussed in detail below, soil finishing systems 12 that include reels enable the operator to create optimal soil for seeding and farming without frequent maintenance or repair. Soil finishing systems 12 are located in the rear portion of the tandem disk system 10, which may be attached to a tractor via hitch assembly 14. Hitch assembly 14 may be pivotally coupled to frame 16. Frame 16 includes several structural members that are used to connect and support front disk row 18 and rear disk row 20.

In certain embodiments of the tandem disk system 10, the disk rows 18 and 20 may also be referred to as gangs of disk blades. As shown, tandem disk system 10 includes only disks mounted to tool bars and uses no other tools or devices to open the soil. The disk rows 18 and 20 include disks mounted to tool bars that are part of frame 16. In an embodiment, front disk row 18 includes two sets of disk blades 21 that are mounted to two tool bars 23, which converge at an angle toward the center 25 of frame 16. In another embodiment, tool bars 22 may converge in an X-shape, wherein tool bars 23 and 27 converge toward the center to form an “X.” Further, the disk blades 21 are configured to grab and open soil, turning it outward as the tandem disk system 10 is pulled across the ground. Rear disk row 20 includes two rows of disk blades 21 mounted to two tool bars 27, which converge at an angle (e.g., V-shape configuration) toward the center 25 of the frame 16. In an embodiment, the rear disk row 20 is configured to draw the soil inward in contrast to the outward turning of the soil by the front disk row 18.

Tandem disk system 10 also includes transport wheels 22, which may be extended to raise the ground contacting disks 21 from the ground when the system is in transport. Transport wheels 22 may be located in a plurality of positions under frame 16 to support the tandem disk system 10 when the disks 21 are elevated. Included in the rear portion of frame 16 are rear-frame cross bars 24, which are generally transverse to hitch assembly 14 and to the direction in which the tandem disk system 10 is towed. Hitch assembly 14, frame 16, and rear frame cross bars 24 may be made of any suitable durable and strong material, such as steel.

Soil finishing systems 12 are mounted to rear frame cross bar 24 by support arms 26. In an embodiment, two support arms 26 are used to support each of the finishing reels 28 located on soil finishing systems 12 aft of the finishing reels 28. In the present context, finishing reels 28 may also be referred to as finishing baskets. Finishing reels 28 may be used to contact the soil after the ground has been broken up by front disk row 18 and rear disk row 20. In particular, the tandem disk rows 18 and 20 may tend to leave the ground with many clods of unbroken soil, rough with ridges and valleys. The finishing reels 28 may be used to create a smooth finish to the broken up ground. The configuration of soil finishing systems 12 may reduce or eliminate the need for extra passes through the field to finish the soil, thereby reducing the time and costs associated with preparation for seed deposition. Further, the robust design of the finishing reels 28 and systems 12 reduces breakage and the effects of wear on the assembly.

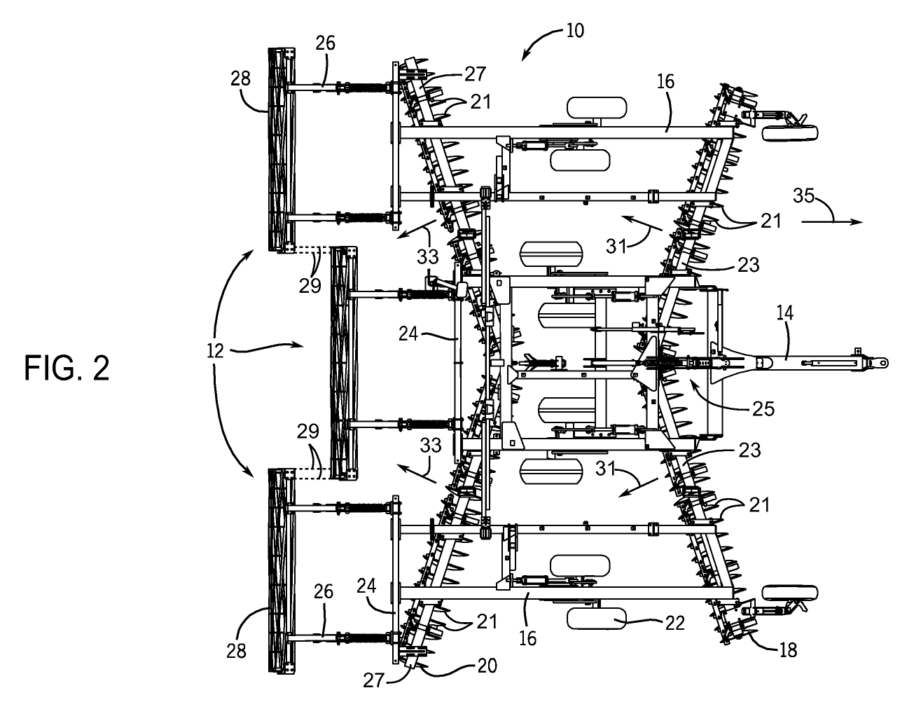

FIG. 2 is a top view of an embodiment of tandem disk system 10. The figure shows soil finishing systems 12, frame 16, front disk row 18, and rear disk row 20. As previously discussed, front disk row 18 includes two sets of disk blades 21 that are mounted to tool bars 23, which converge toward the middle 25 of frame 16 at an angle. Similarly, rear disk row 20 includes two tool bars 27 having disk blades 21, which converge toward the center 25 of frame 16 at an angle. As illustrated, the angled blades are opposite from one another. The opposite V-shapes enable dirt and soil to be opened and moved outward 31 by the front disk row 18 and moved back inward 33 by rear disk row 20. After the ground has been opened by the tandem disk rows 18 and 20, finishing reels 28 contact the soil to smooth out the ground to optimize the surface for seed deposition. In an embodiment, the systems includes three soil finishing systems 12 with associated finishing reels 28. However, any number of finishing reels 28 may be used to optimize the soil finish of the field. As illustrated, the finishing reels 28 are arranged in a staggered manner, shown by lines 29, such that the reels 28 partially overlap one another in the direction of movement 35. In this manner, the reels 28 provide full coverage over the soil.

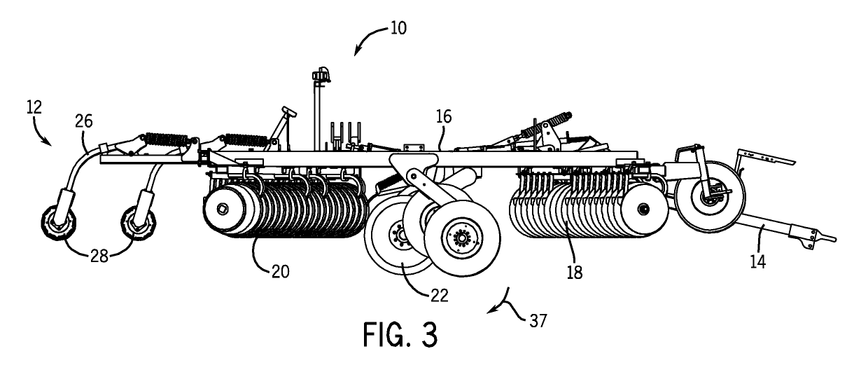

FIG. 3 is a side view of an embodiment of the tandem disk system 10. The figure shows front disk row 18, rear disk row 20, as well as soil finishing systems 12. In the diagram, transport wheels 22 are extended 37 to elevate the tandem disk rows 18 and 20 and finishing reels 28 from contacting the ground.

In an embodiment, the tandem disk system 10 may be described as a soil conditioning system. Further, disk rows 18 and 20 of the soil conditioning system include only disks to break the soil. After the soil is broken by the disk rows 18 and 20, the finishing reels 28 break up clods and further condition the soil for planting or seeding by another implement. That is, the tandem disk system 10 only conditions the soil with disks and does not include planting, seeding, cultivating or other similar tools. Further, the robust design of the tandem disk system 10 and soil finishing systems 12 enable an optimal farming soil surface after one pass of the tractor and implement, reducing the amount of time and fuel used by an operator. The design of finishing reels 28 is durable, able to withstand stones and other debris and further break up large clods.

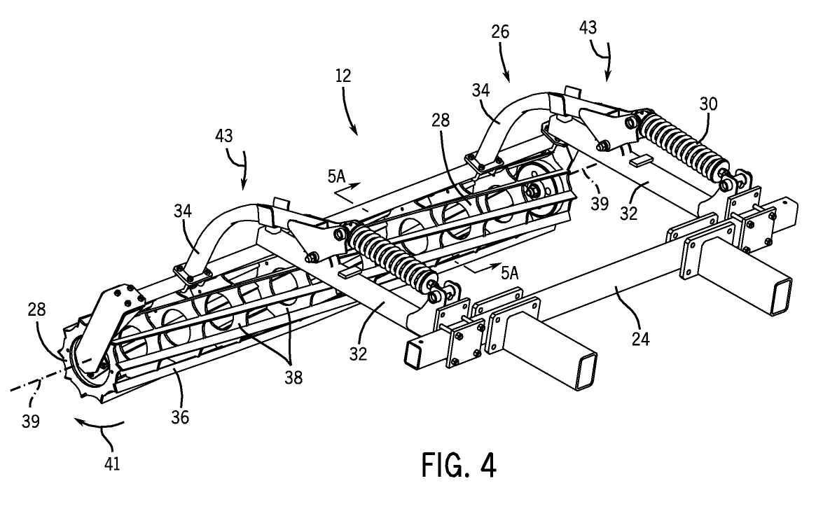

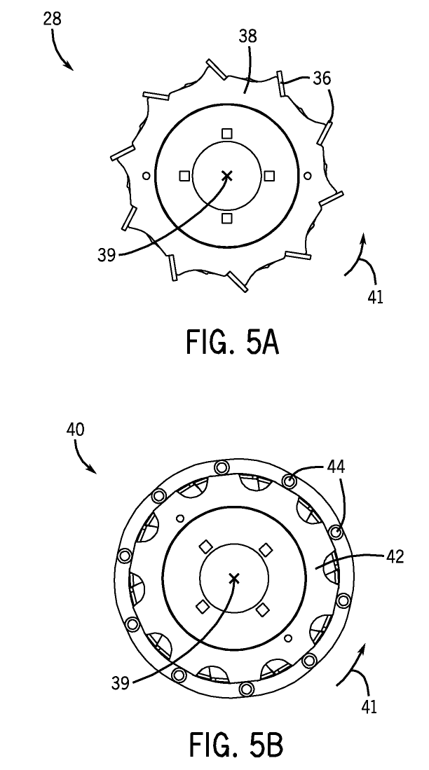

FIG. 4 is a perspective view of an embodiment of soil finishing system 12 coupled to the rear frame cross bar 24. Included in soil finishing system 12 are biasing member 30 and support arm member 32. The present embodiment includes a spring as the biasing member 30, however any suitable biasing device may be used to urge finishing reel toward the ground, as will be described below. Further, curved arm member 34 is coupled to the finishing reel 28. In an embodiment, finishing reel 28 includes flat soil contacting bars 36, which may used to split dirt clods and loosen the soil. Structural reel disks 38 support soil contacting bars 36 as reel 28 rotates about axis 39. Finishing reels 28 rotate in direction 41 as they go over soil, smoothing the terrain and breaking up clods. The arrangement of soil finishing system 12 and finishing reel 28 is such that soil contacting bars 36 rotationally contact the ground or soil as the finishing system 12 is pulled across a field. As illustrated, soil contacting bars 36 twist about axis 39, partially winding in helical manner. In an embodiment, support arms 26 include biasing members 30 and other adjustable components that enable adjustment of the height or elevation of finishing reels 28 relative to the tandem disks 21. The components of support arms 26 also allow for downward force to be applied in direction 43 to the finishing reels 28, urging contact with the soil as the finishing reels 28 are drawn across the field. Further, the biasing members 30 and other components of support arms 26 may be adjusted to increase or decrease the force applied to finishing reel 28. Sectional line 5A is shown to illustrate the cross section of finishing reel 28 that will be illustrated in FIG. 5A.

FIG. 5A shows a cross sectional side view of an embodiment of the finishing reel 28 shown in FIG. 4. In an embodiment, finishing reel 28 includes flat soil contacting bars 36 as well as structural reel disk 38. As shown in the illustration, flat soil contacting bars 36 have a rectangular cross-sectional shape. As is shown in FIG. 4, a plurality of structural reel disks 38 are disposed throughout finishing reel 28 to support soil contacting bars 36. Another embodiment of the finishing reel 28 of soil finishing system 12 is shown in FIG. 5B and generally represented by the numeral 40. The embodiment of finishing reel 40 also features a structural reel disk 42 as described above. In the embodiment, round soil contacting bars 44 are used to break-up and firm the soil as the finishing reel 40 is drawn across the ground. As shown in FIGS. 5A and 5B, the finishing reels rotate in direction 41, about axis 39 as the tandem disk system is pulled across a terrain. The finishing reels 28 and soil contacting bars 36 or 44 may be composed of stainless steel, an alloy, or any other suitable durable material. Further, the soil contacting bars 36 or 44 may be comprised of various geometric cross-sectional shapes, including squares, rectangles, circles, triangles or octagons, in order to achieve a desired soil finish. In addition, although the present embodiments illustrate finishing reels 28 in a generally cylindrical shape, other reel shapes may be implemented.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A soil conditioning system, comprising:
a ground breaking disk system mounted on a frame including only disks for contacting and breaking soil, wherein the frame is coupled to a hitch assembly and configured to be towed during operation; and
a soil finishing reel extending from at least one support arm coupled to the frame aft of the ground breaking disk system, wherein the at least one support arm comprises a biasing member to urge the soil finishing reel into engagement with the soil.

2. The system of claim 1, comprising a plurality of soil finishing reels extending from a respective plurality of support arms coupled to the frame aft of the ground breaking disk system.

3. The system of claim 2, wherein the soil finishing reels are staggered to at least partially overlap one another in a direction of movement of the soil conditioning system.

4. (canceled)

5. The system of claim 1, wherein the at least one support arm is configured to urge the soil finishing reel toward the soil.

6. The system of claim 5, wherein the at least one support arm is configured to enable an adjustment of a downward force on the soil finishing reel.

7. The system of claim 1, wherein the soil finishing reel comprises soil contacting bars disposed in a generally cylindrical arrangement about an axis.

8. The system of claim 7, wherein the soil contacting bars are round bars.

9. The system of claim 7, wherein the soil contacting bars are flat bars.

10. The system of claim 7, wherein the soil contacting bars are twisted at least partially about the axis.

11. The system of claim 1, wherein the ground breaking disk system comprises a first row of disks and a second row of disks located aft of the first row of disks, the disks being configured to break the soil, wherein the first row and second row of disks are each in an angled configuration.

12. A soil conditioning system, comprising:
a ground breaking disk system mounted on a frame including only disks for contacting and breaking soil, wherein the frame is coupled to a hitch assembly and configured to be towed during operation;
a support arm extending from the frame aft of the ground breaking disk system; and
a rotary soil finishing reel coupled to the support arm, wherein the soil finishing reel comprises soil contacting bars that are configured to contact and shape the soil by rotation of the soil finishing reel after the soil has been opened by the ground breaking disk system.

13. The system of claim 12, wherein the soil contacting bars are disposed in a generally cylindrical arrangement about an axis.

14. The system of claim 13, wherein the soil contacting bars are round bars.

15. The system of claim 13, wherein the soil contacting bars are flat bars.

16. The system of claim 13, wherein the soil contacting bars are twisted at least partially about the axis.

17. (canceled)

18. The system of claim 12, wherein the support arm comprises a biasing member configured to urge the finishing reel downward toward the soil.

19. The system of claim 18, wherein the support arm is configured to enable an adjustment of a downward force on the soil finishing reel.

20. A soil conditioning system, comprising:
a first row of disks coupled to a frame;
a second row of disks located aft of the first row of disks and coupled to the frame, wherein the frame includes only disks for contacting and breaking soil, and wherein the frame is coupled to a hitch assembly and configured to be towed during operation; and
a plurality of rotary soil finishing reels aft of the second row of disks supported by arms coupled to the frame, wherein each arm includes a biasing member to urge the finishing reels downward.

21. (canceled)

22. The system of claim 20, wherein the soil finishing reels comprise round soil contacting bars disposed in a generally cylindrical arrangement about an axis.

23. The system of claim 20, wherein the soil finishing reels comprise flat soil contacting bars disposed in a generally cylindrical arrangement about an axis.

24. The system of claim 20, wherein the soil finishing reels comprise rounded soil contacting bars configured to break soil clods and firm the soil.

25. The system of claim 20, wherein the arms are configured to urge the soil finishing reels downward toward the soil and are configured to enable an adjustment of a downward force on the soil finishing reels.
